(19) United States
(12) Patent Application Publication
(10) Pub. No.: US 2005/0251916 A1
(43) Pub. Date: Nov. 17, 2005

(54) Collapsible lower structure for beds

(76) Inventor: Adan Elizondo, Garza Garcia (MX)

Correspondence Address: John A. Thomas, 2200 One Galleria Tower, 13355 Noel Road, L.B. 48, Dallas, TX, 75240-1518, US

(21) Appl. No.: 10/936,998

(22) Filed: Sep. 8, 2004

(30) Foreign Application Priority Data
May 13, 2004 (MX) PA/A/2004/004529

(51) Int. Cl. A61G 7/012

(52) U.S. Cl. 5/611; 5/600

(57) ABSTRACT

The present invention refers to an improved bed platform, specifically it refers to a lower collapsible structure to support a mattress or mattresses, characterized by consisting of a collapsible structure on a lower platform which may be built into a bed, which acts simultaneously on vertical and horizontal axes, to move an upper platform on which a mattress or mattresses rest in a collapsed resting position to an elevated and displaced working position. The collapsible structure interacts with elastic raising means on one end; impulsion means on the lower platform to force, along with the elastic means, the upper platform to a working position; hooking and holding means of the collapsible structure placed on the sides of the lower platform for releasing the structure and directing the upper platform to the elevated working position; and tension means to maintain the working position and assure a limit in the maximum height and displacement movement of the upper platform or the collapsible structure with respect to the lower platform.

### CLAIM FOR PRIORITY

This application claims the priority of Mexican Patent Application serial number PA/a/2004/004529, filed May 13, 2004, and having the title “Estructura Inferior Desplazable Para Camas.”

### FIELD OF THE INVENTION

The present invention is related to an improved bed; specifically it refers to a lower displaceable structure which supports a mattress which allows positioning an upper platform in an elevated and displaced position with respect to a lower platform.

### BACKGROUND OF THE INVENTION

In the field of design and building of beds for sleeping, significant advances have been made, especially in hospital beds or beds for the ill or people with physical limitations, which makes them more easily accessible, more comfortable and allows for easy and simple maneuverability. In some cases, advances have allowed for varying the sleeping position. That is to say, they are designed to be operated automatically to allow for placing the platform in different positions with different angles of inclination, and also at different heights. The majority of these beds require complex structures and electric mechanisms which make possible the maneuverability and multiple positions of the sleeping platforms.

In existing beds, the structure typically does not allow for graduation of strength nor velocity in its activation, nor it does it have a mechanism which stops the platform from being raised higher than its top position, thus making a toppling of the sleeping platform possible.

There is also a risk with such beds that once the platform is in the desired position, the platform is pushed downward but in the opposite direction of the head of the bed, thus causing an excessive displacement of the sleeping platform from its base and the resultant loss of the center of gravity and possible toppling over. Nor do such beds typically have a mechanism that maintains the sleeping platform in a working position, thus avoiding its acidental return to the resting position.

Existing beds typically have four collapsible metallic elements on the ends of the sides which, when changed from the working position to the resting position, scrape against the lower metallic structure turning these collapsible metallic elements into guillotines that can be be quite dangerous for the person who is using the bed. Also the arrangement is inconvenient, since the bed sheets can easily be caught between the supports and the side structure.

Thus a moveable lower structure for a bed which resolves the above-mentioned inconveniences and that also provides more advantages of operation and maneuverability, and which may be operated without the need of external energy, would be very advantageous.

### SUMMARY

A collapsible structure for beds comprises a lower frame; the frame having a floor;
at least one front and at least one rear cross support, and at least one longitudinal support supported by the floor. There are at least two front arms; the front arms pivotally attached to the front cross support and joined so as to pivot together. The structure has at least two rear arms; the rear arms pivotally attached to the rear cross support; and also upper support arms pivotally connected between the front and rear arms, for supporting a platform.

One or more springs are connected between the front arms and the front cross support. There is a latch for holding the two front arms to the longitudinal support so as to hold the structure in its collapsed position, and a pedal outside the frame operatively connected to the latch for releasing the two front arms from the longitudinal support.

There is a means for adjusting the height of the structure in its raised position. The means for adjusting comprises a rigid tension arm. The open end of the rigid tension arm is pivotally connected to the front arms, and the longitudinal support supports a horizontal chamber for receiving the closed end of the rigid tension arm and holding it against the force of the spring that urges the front arms away from the longitudinal support. The place of connection of the rigid tension arm to the first front arms is adjustable, so that the resulting height and displacement of the bed platform may be set at a predetermined position.

A second spring is connected to the longitudinal support and pushes against the collapsed structure to assist the raising of the collapsible structure from its lowered position when the latch is released.

### DRAWINGS

FIG. 1 shows a conventional view of the moveable lower structure for a bed, in its working position.

FIG. 2 shows a side view of the means for affixing the collapsible structure (in its collapsed state) to the upper platform on which the mattress of the bed is held.

FIG. 3 shows a conventional view of the rigid tension arm as a tensing and support means of the collapsible structure (in its upright position) which holds up the upper platform on which the mattress of the bed is held.

FIG. 4 shows a side view of the height adjusting element for the horizontal raising of the position of the upper platform in working (upright) position.

For a better understanding, a detailed description of various embodiments of the invention as shown in the drawings will be made, the annexed drawings being illustrative but not limiting in their presentation.

### DETAILED DESCRIPTION

The details characteristic of the lower moveable structure for beds are clearly shown in the following description and in the illustrative drawings which are annexed, the numbers in the description referring to the same numbered parts in the drawing.

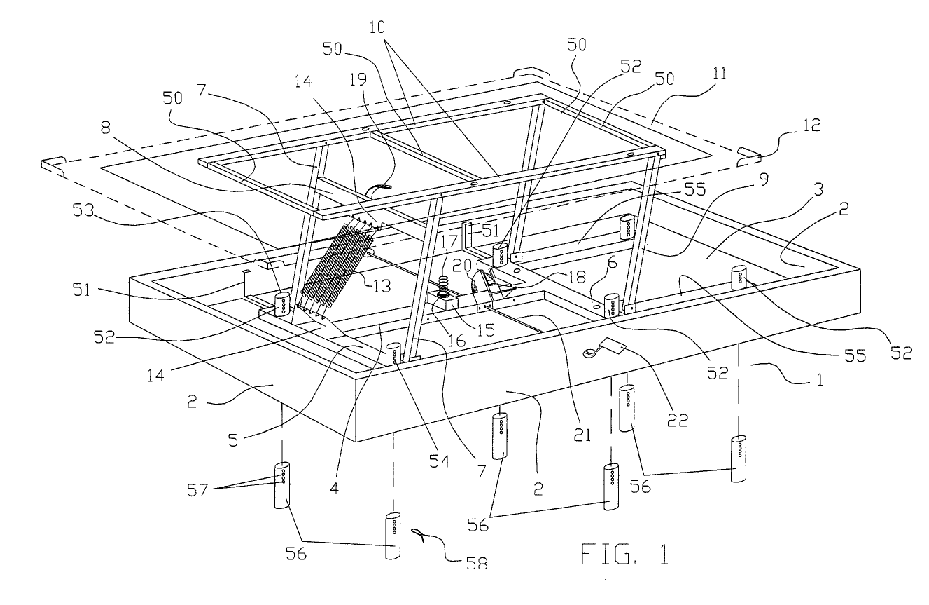

FIG. 1 shows a conventional view of the lower collapsible structure for beds in its working position. In the figure, the structure consists of a lower frame 1 with side walls 2 and a bottom floor 3, on which a longitudinal central element 4 for affixing the holding and connecting means, and the impulsion means, is placed. There is a first transversal front support 5 and a second rear cross support 6, the transversal front support element 5 being comprises a pair of collapsible front arms 7 with a horizontal arm 8 that connects them near the upper edge. The rear cross support 6 is comprises a pair of rear collapsible arms 9; each arm of the pair of collapsible front arms 7 and collapsible rear arms 9 being connected on the top in articulated form to a pair of upper side support arms 10 with transversal supports 50 which provide greater structural strength. The same arms 10 together with supports 50 support and hold an upper platform 11 with corner supports 12 for supporting the mattress (not shown). The arms of the front pair of collapsible arms 7 and the rear pair of collapsible arms 9 are articulately connected on their upper and lower ends.

The first and second front 5 and rear 6 transversal support elements comprise assembled and adjustable end side extensions 51 that are affixed to the inside of the outside side walls 2 of the lower frame 1.

On the lower platform there are various cylindrical bodies 52 with top end top 53 and a series of holes 54 placed vertically and diametrically opposite one another, distributed at specific points with preferably at least two on the first and two on the second front 5 and rear 6 transversal support elements, located in front of the pivotal joining points of the collapsible front 7 and rear 9 arms, passing through the supports to the front face of the lower frame 1. There are at least two cylindrical bodies 52 with the same characteristics, near the head end of the bed, affixed on extensions 55, whose main function it is to provide direct support to the pair of upper side support arms 10. The upper support arms 10 hold up the upper platform 11 in the resting position, this pair of front 7 and rear 9 arms being in the collapsed position, and into which from the bottom may be inserted various cylindrical legs 56 with transversal vertical holes 57 which allow for the insertion of pins 58 in the corresponding holes of the cylindrical bodies 52 in order to regulate the desired height and raise even more the upper platform if need be.

The horizontal arm 8 (which is joined to the front pair of collapsible arms 7) and the first transversal front support element 5 are connected by means of first elastic raising means 13 (such as springs, elastic bands, or at least one gas cylinder) that are joined together at both ends by means of connecting devices 14 with a number of holes where the number of first elastic means 13 are connected.

The various elongated springs or elastic raising means 13 are stretched, thus accumulating energy when the superior platform 11 is pushed or lowered, thus collapsing the front pair of collapsible arms 7 and the rear pair of collapsible arms 9.

The central section of the longitudinal central support 4 comprises an inclined support 15 with a connecting means 16 to which at least one second elastic raising means 17 is attached on the longitudinal support at the place where horizontal arm 8 is latched to the front pair of collapsible arms 7 when the structure is lowered. The second elastic raising means 17 is preferably a coil spring that stores energy when it is compressed, but it could also be a gas-lift device or spring combination. When the upper platform 11 is lowered, the second elastic means 17 is compressed just before the upper platform 11 reaches its resting position, thus storing energy which contributes to a smooth and harmonious beginning of horizontal and raising movement(in the opposite direction of the position of the head of the bed) of upper platform 11 as it moves towards its working position. In the same way, the energy accumulated in the first elastic raising means 13 (accumulated when the upper platform 11 is lowered to the resting position) allows the upper platform 11 to smoothly and harmoniously return to its resting position.

The longitudinal central element 4 for affixing the connecting and holding means also includes a holding means 18 comprising a hook 19 placed on the horizontal arm 8 that connects to the front pair of collapsible arms 7 near the upper end. The holding means 18 holds the connecting hook 19 when the upper platform 11 is lowered and the front pair of collapsible arms 7 and rear pair of collapsible arms 9 are folded down, thus keeping the upper platform 11 in the resting position. The holding means 18 includes a release 20 for the hook 19 activated by means of a shaft 21 placed transversally across the bottom frame 1. The shaft has a switch pedal 22 which is outside the side walls 2 of the lower frame 1 and which may have an extension which is placed near the headboard to prevent its being a lateral obstacle. Upon activating the switch pedal 22, release means 20 releases connecting hook 19, thus permitting the horizontal movement and raising of the upper platform 11.

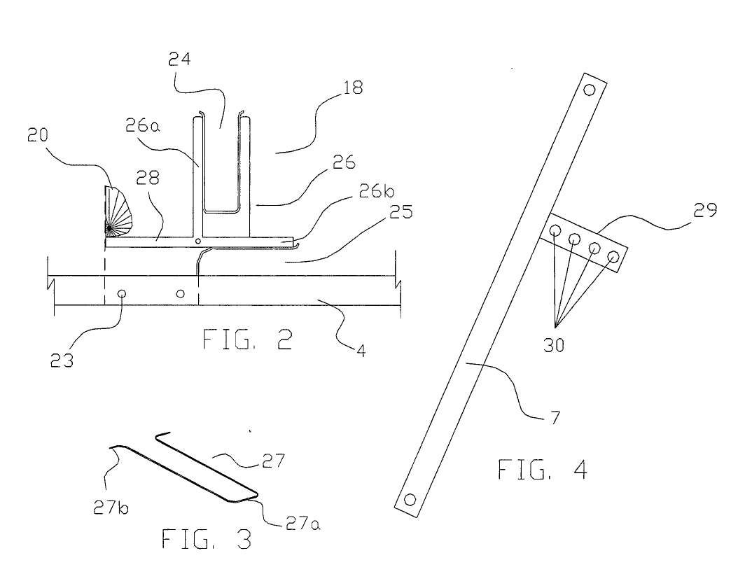

With reference to FIGS. 2 through 4, the holding means 18 has a connecting means 23 to connect to the longitudinal central support 4 for affixing the connecting and holding means, the holding means 18 being comprising a vertical connecting chamber 24 which receives and connects the hook 19 (see FIG. 1) to vertical part 26a of the double latch 26 and a horizontal chamber 25 which receives and holds the closed end 27a of the rigid tension arm 27 with the rear horizontal part 26b of double latch 26.

Upon activating the switch pedal 22, shaft 21 turns (see FIG. 1) thus activating the release means 20 which pushes rear horizontal part 28 of double latch 26 downwards, thus making vertical part 26a of double latch 26 (see FIG. 1) retract in the vertical holding chamber 24, as well as the rear horizontal part 26b which holds the closed end 27a of rigid tension arm 27 in horizontal chamber 25.

Adjusting element 29 placed on the horizontal arm 8 (see FIG. 1) which joins collapsible front arms 7, has various holes 30 into which the tangs of the open end 27b of rigid tension arm 27 are hooked, thus permitting adjustment of the height and horizontal movement of the working position of upper platform 11 (see FIG. 1) when the closed end 27a of the rigid tension arm 27 is held in horizontal chamber 25 with the horizontal end part 26b of the double latch 26 of the holding element 18. In FIG. 2, the left side of the holding means 18 (comprising the double latch 26) is closest to the cross arm 8 connected across collapsible front arms 7. Thus the closed end 27a of the rigid tension arm can fall over the double latch 26 and be engaged by the horizontal chamber 25 of the holding means 18. The rigid tension arm 27 is thus held in the horizontal chamber by the force exerted by the elastic raising means 13.

The rigid tension arm 27 serves then two purposes, first, that superior platform 11 (see FIG. 1) does not exceed its maximum height and horizontal movement, thus avoiding tipping over or loss of stability and second, maintaining the working position of superior platform 11, preventing its folding down accidentally.

The invention has been sufficiently described so that a person skilled in the art may reproduce and obtain the results which we have mentioned in the present invention. However, if any person skilled in the art of the technique involved in the present invention, makes modifications not described in the present application but makes use of the material claimed herein for the application of these modifications in the determined structure or the method for manufacturing the same, the structures fall within the broad scope and ambit of the invention as is herein set forth.

1. A collapsible structure for beds, the structure comprising:
a lower frame; the frame having a floor;
at least one front and at least one rear cross support and at least one longitudinal support supported by the floor;
at least two front arms; the front arms pivotally attached to the front cross support and joined so as to pivot together;
at least two rear arms; the rear arms pivotally attached to the rear cross support;
upper support arms pivotally connected between the front and rear arms, for supporting a platform;
a first elastic raising means connected between the front arms and the front cross support;
a means for holding the two front arms to the longitudinal support so as to hold the structure in its collapsed position, and a means for releasing the two front arms from the longitudinal support; and,
a means for adjusting the height of the structure in its raised position.

2. The collapsible structure for beds of claim 1, where the first elastic raising means comprises one or more springs.

3. The collapsible structure for beds of claim 1, where the first elastic raising means comprises one or more elastic bands.

4. The collapsible structure for beds of claim 1, where the first elastic raising means comprises at least one gas-lift cylinder.

5. The collapsible structure for beds of claim 1, further comprising a second elastic raising means connected to the longitudinal support to assist the raising of the collapsible structure from its lowered position.

6. The collapsible structure of claim 5 where the second elastic means is a coil spring.

7. The collapsible structure for beds of claim 1, where the means for holding the two front arms to the longitudinal support is a latch.

8. The collapsible structure for beds of claim 1 where means for releasing comprises a pedal outside the frame operatively connected to open the latch.

9. The collapsible structure for beds of claim 1 where the means for adjusting the height of the structure in its raised position comprises:
a rigid tension arm, the rigid tension arm having an open end and a closed end;
the open end of the rigid tension arm pivotally connected to the front arms; and,
the longitudinal support supporting a horizontal chamber for receiving the closed end of the rigid tension arm and holding it against the force of the elastic raising means.

10. The collapsible structure for beds of claim 1 where the place of connection of the rigid tension arm to the front arms is adjustable.

11. A collapsible structure for beds, the structure comprising:
a lower frame; the frame having a floor;
at least one front and at least one rear cross support and at least one longitudinal support supported by the floor;
at least two front arms; the front arms pivotally attached to the front cross support and joined so as to pivot together;
at least two rear arms; the rear arms pivotally attached to the rear cross support;
upper support arms pivotally connected between the front and rear arms, for supporting a platform;
a means for holding the two front arms to the longitudinal support to hold the structure in its collapsed position, and a means for releasing the two front arms from the longitudinal support; and,
a means for adjusting the height of the structure in its raised position.

12. A collapsible structure for beds, the structure comprising:
a lower frame; the frame having a floor;
at least one front and at least one rear cross support and at least one longitudinal support supported by the floor;
at least two front arms; the front arms pivotally attached to the front cross support and joined so as to pivot together;
at least two rear arms; the rear arms pivotally attached to the rear cross support;
upper support arms pivotally connected between the front and rear arms, for supporting a platform;
a first elastic raising means connected between the front arms and the front cross support;
a means for holding the two front arms to the longitudinal support to hold the structure in its collapsed position; and,
a means for releasing the two front arms from the longitudinal support.

13. A collapsible structure for beds, the structure comprising:
a lower frame; the frame having a floor;
at least one front and at least one rear cross support and at least one longitudinal support supported by the floor;
at least two front arms; the front arms pivotally attached to the front cross support and joined so as to pivot together;
at least two rear arms; the rear arms pivotally attached to the rear cross support;
upper support arms pivotally connected between the front and rear arms, for supporting a platform;
one or more springs connected between the front arms and the front cross support;
a latch for holding the two front arms to the longitudinal support so as to hold the structure in its collapsed position, and a pedal outside the frame operatively connected to the latch for releasing the two front arms from the longitudinal support;
a means for adjusting the height of the structure in its raised position, the means for adjusting comprising:
a rigid tension arm, the rigid tension arm having an open end and a closed end;
the open end of the rigid tension arm pivotally connected to the front arms; and,
the longitudinal support supporting a horizontal chamber for receiving the closed end of the rigid tension arm and holding it against the force of the spring;
where the place of connection of the rigid tension arm to the first front arms is adjustable;
a second spring connected to the longitudinal support to assist the raising of the collapsible structure from its lowered position.
